(19) United States
(12) Patent Application Publication
(10) Pub. No.: US 2008/0276321 A1
(43) Pub. Date: Nov. 6, 2008

(54) Secure Transfer Of Product-Activated Software To A New Machine Using A Genuine Server

(75) Inventors: Mark K. Svancarek, Redmond, WA (US); Caglar Gunyakti, Sammamish, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/743,476

(22) Filed: May 2, 2007

(51) Int. Cl. G06F 7/04

(52) U.S. Cl. 726/26

(57) ABSTRACT

Systems and methods for secure transfer of product-activated software are disclosed. A user may request a license transfer from an original machine to a new machine. The request cause the machine identity and proof of purchase from the original machine to be sent to an activation service. The activation service may add the proof of purchase to a transfer list and mark as invalid the existing association between the original machine identity and the proof of purchase. The activation service may push the transfer list to a genuine service, which may issue a revocation certificate to the original machine. The proof of purchase may then be applied to the new machine. The activation service may create a new association between the identity of the new machine and the proof of purchase, and deliver a perpetual license certificate to the new machine.

### BACKGROUND

It is common for a user of retail software to move the software to another machine. The new machine may be better suited than the original machine, or it might be part of a machine replacement where the old machine is completely retired and replaced by the new machine. This behavior may be limited by the rights granted in the end-user license agreement (“EULA”) but it usually allowed in some form or another.

Regardless of the details, such a transfer is more difficult when the software uses product activation. Product activation attempts to bind a license to the identity of the machine itself, determined by generating a unique or semi-unique fingerprint of the machine hardware configuration.

Product activation prevents unauthorized use by preventing the software from running on a machine with a different hardware identity than the one used for product activation. When the software has been transferred, the product activation system will detect that the hardware identity does not match, and will require the user to reactivate the software.

This poses problems for the software publisher. Unless the user has contacted the activation service beforehand, the activation service will not grant a new activation for the new hardware identity. And once the new identity has been activated, the publisher has no secure way to know if the original machine has been retired or not.

This situation has led to an impasse where users demand, and receive in the EULA, rights that cannot be securely enforced by the publisher. Publishers attempt to limit the exposure to piracy risk by forcing the end user to perform a support call before receiving the new activation for the new hardware identity. No attempt to detect whether machines are actually retired or not is performed. The situation results in a bad user experience and results in additional cost and risk for the publisher.

Known conventional certificate revocation systems assume connectivity to the certificate issuance system, which may be, for example, the activation system. Such connectivity can be assumed because certificates have a “life to live” and eventually expire unless renewed, even in the absence of deliberate revocation.

Today most software sold does not require constant renewal of the product activation certificates. This is because the license model is a one-time purchase of a “perpetual license.” Even in the enterprise business space, where the business model often is annuity-based, the lack of secure revocation ability has often resulted in continuance of perpetual licensing at the certificate level.

In other cases, some existing systems already support constant renewal of the license certificates. In such cases, the business model may be for a perpetual license, but at the certificate level licensing is actually a lease. That is, if the software does not maintain contact with the certificate issuance system, the software will not run normally.

It should be understood that both of the methods described above may result in product behavior that is different from the license language. This can lead to confusion and a poor experience. Also, there are many circumstances where the leased-license model is inferior due to connectivity, cost of lease license management, and the like. It would be desirable, therefore, if there were available a method of revocation and secure license transfer that supports the perpetual license model directly.

### SUMMARY

By extending existing interfaces to an activation service (i.e., a certificate issuance service), an end user may be enabled to indicate that a machine is to be revoked. A genuine service, which may be a related, but separate, certificate issuance system, may be employed to determine that the machine is actually revoked. Once confirmed, the activation service may issue a new perpetual license to a new machine of the user's choice.

As described herein, the user may apply a user interface (“UI”) on the original machine to request a license transfer. The request may harvest the machine identity and proof of purchase from the original machine and send them to the activation service. The same UI may initiate a series of genuine service requests until the genuine service responds with a revocation certificate.

The activation service may add the proof of purchase to a transfer list and mark as invalid the existing association between the original machine identity and the proof of purchase. The activation service may push the transfer list to the genuine service. The genuine service may respond to the request from the original machine by issuing a revocation certificate. The genuine service may notify the activation service of a successful revocation. A confirmation may be sent from the original machine to the activation service.

The user may manually apply the proof of purchase to the new machine, or a UI may be used to transfer the proof of purchase from a digital locker to the new machine. The software on the new machine may attempt to activate, and the activation service may create a new association between the identity of the new machine and the proof of purchase. The activation service may deliver a perpetual license certificate to the new machine, enabling the user to run the software perpetually on the new machine.

### BRIEF DESCRIPTION OF THE DRAWINGS

FIG. 1 is a functional block diagram illustrating a system and method for secure transfer of product-activated software to a new machine using a genuine service.

FIG. 2 is a block diagram of an example computing environment in which example embodiments and aspects may be implemented.

### DETAILED DESCRIPTION

### Overview

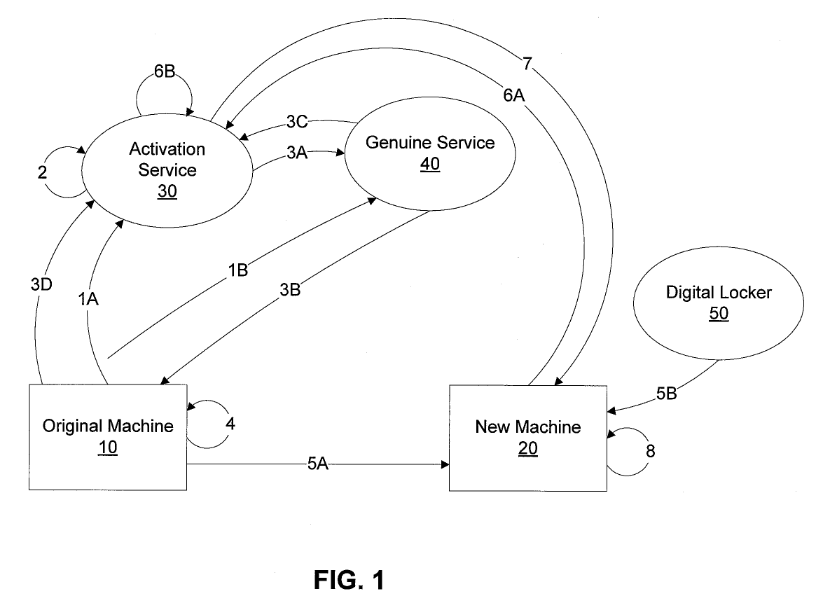

FIG. 1 is a functional block diagram illustrating a system and method for secure transfer of product-activated software from an original machine 10 to a new machine 20. In a typical scenario, the original machine 10 may be running licensed software, where the license is tied to a hardware identity associated with the original machine 10. An end-user may desire, for whatever reason, to move the licensed software to the new machine 20. The new machine 20 may have a different hardware identity.

In prior systems, an attempt to run the licensed software on the new machine 20 would typically result in denial, and, possibly an offer to re-activate the software. However, reactivation would typically not be possible because the hardware identity of the new machine 20 differs from the hardware identity associated with the license (i.e., the hardware identifier of the original machine 10). The software may offer a new license, but, typically and understandably, the user would not want to buy a new license. So the user typically ends up having to make a product call, and the software publisher will typically grant a new license for the new hardware.

The publisher typically does not like this situation, because fielding the support call is costly and time-consuming, and also because the publisher would not be able to tell whether the user is actually running the software twice—i.e., on both the original and new machines. The user also typically does not like this scenario because the user purchased the right to move the software to a new machine, but was then required to make a product call to effect that right.

### Secure Transfer of Product-Activated Software to a New Machine Using a Genuine Service

A system and method as depicted in FIG. 1 provides for secure transfer of product-activated software to a new machine using a genuine service. The system may include an activation service 30, a genuine service 40, and an online digital locker 50. The services 30, 40, and 50 are shown functionally in FIG. 1, and may be implemented on one or more physical machines, each of which may be in communication with the original machine 10 and the new machine 20 via a communications network, such as the Internet, for example.

Computer-executable instructions, such as program modules, being executed by a computer may be used. Generally, program modules include routines, programs, objects, components, data structures, etc., that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The activation service 30 may maintain a database of how many times a proof of purchase token has been associated with a machine identity. A proof of purchase token is a token that is hard to counterfeit, such as a CD key or product key for example. It may also maintain a list of blocked proofs of purchase, i.e., proofs or purchase that are no longer allowed to create new associations. A proof of purchase may be blocked, for example, because a maximum number of associations has been reached, or because the proof of purchase has been used in ways that violate a license agreement, e.g., where it has been discovered that the key was leaked onto the Internet and people are freely sharing it.

The activation service 30 may include a business rule checker that knows the maximum allowable number of such associations. Business rules could also be implemented for geographic blocking. That is, the activation service 30 may maintain a map of IP addresses to rules, and block the transfer to deny an attempt to move the software to a geographic location known to be a piracy risk.

The genuine service 40 may have access to the list of blocked proofs of purchase and may be able to securely deliver a special certificate capable of revoking the license certificates already on a machine, should a machine with a blocked proof of purchase ever access the genuine service. The genuine service 40 and the activation service 30 may be separate services, or a single combined service.

Activation may be a required process for initial installation of certain software. It is well-known, however, that the security of such systems may be compromised over time. Accordingly, it may be desirable for software on a given machine to contact the genuine service 40 from time to time to ensure that its key is genuine. For example, a user may have activated certain software on a certain machine with a certain key. Subsequently, the key may be blocked, through no fault of the user. Consequently, the key, which was genuine during initial activation, is no longer genuine.

The genuine service 40 may provide a mechanism for optional call back. Incentives may be given to encourage such call back. Such incentives may provide advantages to the user for striving to remain genuine. Such incentives may includes, for example, free software, bonuses, extra features, or the like. As the call back may be optional, a certain action by the user may be required to initiate the call back. Though the software may “threaten” to do or not do something if user does not call back, the user may nevertheless still be given an option to call back, albeit at the risk of software's enacting the “threat.”

The genuine service 40 may determine whether a proof of purchase is genuine, and may deliver a certificate that attests to the state of genuineness. If the proof of purchase is genuine, then the user may be able to exchange the certificate to receive the incentive, e.g., to receive goods and services on internet. If the proof of purchase is not genuine, then the system may inform the user of the non-genuine state, and may perform differently in some way. The certificate may be a revocation certificate, which may indicate that the previous activation has been revoked. A grace period may be provided to allow the user to become genuine again.

The digital locker 50 may maintain a secure record of a user's proofs of purchase for recovery purposes.

As shown in FIG. 1, at step 1A, a user may apply a user interface (“UI”) on the original machine 10 to request a license transfer. The request may harvest the machine identity and proof of purchase from the original machine 10 and send them to the activation service 30. The harvesting software could be on the original machine 10 or a remote server, as long as it is able to access the resources on the original machine 10. At step 1B, the same UI may initiate a series of genuine service requests until a response occurs at step 3B (described below).

At step 2, the activation service 30 may add the proof of purchase to a transfer list and mark as invalid the existing association between the original machine identity and the proof of purchase. The transfer list may be a list of pending requests, maintained by the activation service 30, to transfer software from one machine to another.

At step 3A, the activation service 30 may push the transfer list to the genuine service 40. At this point, the association between the original machine identity and the proof of purchase has been marked as invalid. At step 3B, the genuine service 30 may respond to the request from the original machine 10 by issuing a revocation certificate. Once the revocation certificate is received, the UI in step 1B terminates normally. Thus, the UI initiates the series of genuine service requests until it receives a revocation certificate in reply. In the meantime, the UI will likely receive one or more certificates of a non-revocation nature.

At step 3C, the genuine service 40 pushes a handshake to the activation service 30 notifying the activation service 30 of a successful revocation. For security reasons, the original machine 10 may send a confirmation (at step 3D) to the activation service 30 to verify that it has been revoked.

At step 4, the original machine 10 may continue to run the software for a period allowed by the revocation certificate (typically 30 days). After this period, the software will no longer run on the original machine 10 unless a new proof of purchase is installed and successfully activated.

At step 5A, the user may now manually apply the proof of purchase to the new machine 20. For example, the user could now type the product key into the product key UI of the product to be transferred. In a variation of this method, shown as step 5B, the original proof of purchase may have been stored in the digital locker 50. In this case, a UI may be used to transfer the proof of purchase from the digital locker 50 to the new machine 20.

At step 6A, the software on the new machine 20 will attempt to activate, either by user action or automatically. It should be understood that, in the absence of the handshake from the genuine service 40 to the activation service 30 (as described in step 3C), step 6A would fail. At step 6B, where the activation service received the confirmation at step 3C (and maybe the additional confirmation from the original machine 10), a new association may be created between the identity of the new machine 20 and the proof of purchase.

At step 7, the activation service 30 may deliver a perpetual license certificate to the new machine. Thereafter, at step 8, the new machine 20 may be enabled to run the software perpetually without further contact with any of the services. Thus, a system and method as described herein may provide for secure transfer of product-activated software to a new machine, without the user's having to make a product call.

### Exemplary Computing Arrangement

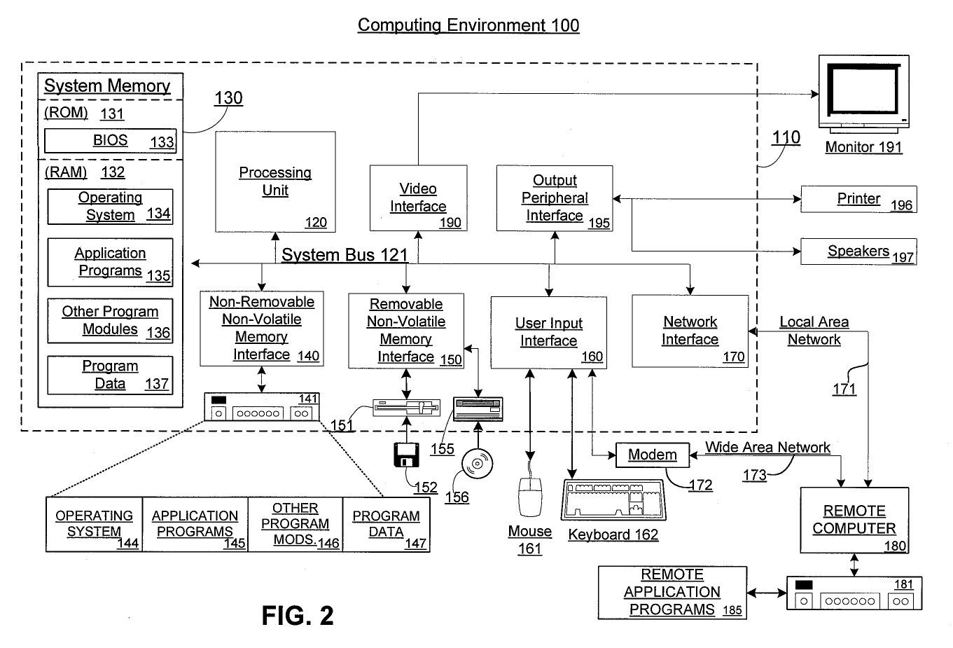

FIG. 2 shows an exemplary computing environment in which example embodiments and aspects may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

Numerous other general purpose or special purpose computing system environments or configurations may be used. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 2, an exemplary system includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for transferring a license from an original machine to a new machine, the system comprising:
an activation service; and
a genuine service,
wherein (i) the activation service receives a request to transfer a software license from a first machine to a second machine, adds a proof of purchase associated with the license to a transfer list, marks as invalid an existing association between the proof of purchase and a hardware identity associated with the first machine, and provides the transfer list to the genuine service, (ii) the genuine service issues a revocation certificate to the first machine indicating that a previous activation of the software on the first machine has been revoked, and notifies the activation service of the revocation, and (iii) the activation service creates an association between the proof of purchase and a hardware identity associated with the second machine, and delivers a perpetual license certificate to the second machine.

2. The system of claim 1, wherein the transfer request harvests a hardware identity and proof of purchase from the first machine and provides them to the activation service.

3. The system of claim 1, wherein the genuine service receives a series of genuine service requests from the first machine, and, after the genuine service receives the transfer list from the activation service, the genuine service issues the revocation certificate to the first machine in response to one of the genuine service requests.

4. The system of claim 1, wherein the activation service accepts the license transfer request based on business rules implemented in connection with the activation service.

5. The system of claim 1, wherein the activation service receives a confirmation from the first machine that the license has been revoked on the first machine.

6. The system of claim 1, wherein the activation service receives a request from the second machine to associate the proof of purchase with the hardware identity associated with the second machine.

7. The system of claim 1, further comprising an online digital locker having the proof of purchase stored thereon, wherein the proof of purchase is transferred from the digital locker to the second machine.

8. A method for transferring a license from an original machine to a new machine, the method comprising:
receiving a request to transfer a software license from a first machine to a second machine;
issuing a revocation certificate to the first machine indicating that a previous activation of the software on the first machine has been revoked; and
delivering a perpetual license certificate to the second machine to enable the software to be run on the second machine.

9. The method of claim 8, further comprising:
marking as invalid an existing association between a proof of purchase associated with the license and a hardware identity associated with the first machine.

10. The method of claim 8, further comprising:
adding a proof of purchase associated with the license to a transfer list; and
pushing the transfer list between a license-issuance service and a license-revocation service.

11. The method of claim 8, further comprising:
creating an association between the proof of purchase and a hardware identity associated with the second machine.

12. The method of claim 8, wherein the transfer request causes a machine identity and proof of purchase to be harvested from the first machine.

13. The method of claim 8, further comprising:
receiving a series of genuine service requests from the first machine; and
issuing the revocation certificate to the first machine in response to one of the genuine service requests.

14. The method of claim 8, further comprising:
creating an association between the proof of purchase and a hardware identity associated with the second machine;
receiving a series of genuine service requests from the first machine; and
after creating the association between the proof of purchase and the hardware identity associated with the second machine, issuing the revocation certificate to the first machine.

15. The method of claim 8, further comprising:
receiving a confirmation from the first machine that the license has been revoked on the first machine.

16. The method of claim 8, further comprising:
receiving a request from the second machine to associate the proof of purchase with the hardware identity associated with the second machine.

17. The method of claim 8, further comprising:
transferring the proof of purchase to the second machine from an online digital locker having the proof of purchase stored thereon.

18. A system for transferring a license from an original machine to a new machine, the system comprising:
a license-issuance service; and
a license-revocation service,
wherein the license-issuance service receives a request to transfer a software license from a first machine to a second machine, the license-revocation service issues a revocation certificate to the first machine indicating that a previous activation of the software on the first machine has been revoked, and the license-issuance service delivers a perpetual license certificate to the second machine to enable the software to be run on the second machine.

19. The system of claim 18, wherein the license-issuance service comprises first computer-executable instructions executing on a first computer, said first computer-executable instructions for receiving the request to transfer the software license from the first machine to the second machine, and for delivering the perpetual license certificate to the second machine; and
wherein the license-revocation service comprises second computer-executable instructions executing on a second computer, said second computer-executable instructions for issuing the revocation certificate to the first machine.

20. The system of claim 19, wherein the first computer and the second computer are the same computer.
